(19) United States
(12) Patent Application Publication
(10) Pub. No.: US 2010/0241299 A1
(43) Pub. Date: Sep. 23, 2010

(54) VEHICLE, ELECTRICAL CHARGING APPARATUS, AND CONTROL METHOD

(75) Inventors: Takahiro Ito, Toyota-Shi (JP); Yuki Inoue, Toyota-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/729,287

(22) Filed: Mar. 23, 2010

(30) Foreign Application Priority Data
Mar. 23, 2009 (JP) JP2009-070053

(51) Int. Cl. G06F 7/00; H02J 7/00

(52) U.S. Cl. 701/22; 320/109; 180/65.29

(57) ABSTRACT

An electrical charging apparatus includes: an electrical charging control ECU that makes a determination about motion of a hybrid vehicle; and a charging-purpose plug which engages with the hybrid vehicle if the amount of movement of the vehicle is less than a predetermined value, and which releases the engagement with the hybrid vehicle if the amount of movement of the vehicle is greater than or equal to the predetermined value. According to the invention, even if the vehicle moves while being charged, the dragging of the charging cable is prevented.

### INCORPORATION BY REFERENCE

The disclosure of Japanese Patent Application No. 2009-070053 filed on Mar. 23, 2009 including the specification, drawings and abstract is incorporated herein by reference in its entirety.

### BACKGROUND OF THE INVENTION

1. Field of the Invention

The invention relates to a vehicle, an electrical charging apparatus, and a control method. More specifically, the invention relates to a vehicle that has an electricity storage apparatus, an electrical charging apparatus that electrically charges the vehicle, and a control method for electrically charging a vehicle.

2. Description of the Related Art

Vehicles and electrical charging apparatuses as mentioned above are disclosed in, for example, Japanese Patent Application Publication No. 5-328532 (JP-A-5-328532), Japanese Patent Application Publication No. 5-328619 (JP-A-5-328619), Japanese Patent Application Publication No. 6-153319 (JP-A-6-153319), and Japanese Patent Application Publication No. 5-276675 (JP-A-5-276675).

Japanese Patent Application Publication No. 5-328532 (JP-A-5-328532) discloses an electric charger in which a safe joint that separates due to tensile force is provided on an intermediate portion of a cable.

Japanese Patent Application Publication No. 5-328619 (JP-A-5-328619) discloses a construction in which an electric charger is caused to safely operate using a signal from a switch that detects the state of connection of a connector, a signal from a break detector that is provided on a safe joint and that breaks due to tensile force that acts on a cable, and a charging start signal.

Japanese Patent Application Publication No. 6-153319 (JP-A-6-153319) discloses a technology that prevents breakage of a cable because a battery-side connector and a vehicle body-side connector disconnect from each other when a battery carrier moves forward relative to a vehicle body.

Japanese Patent Application Publication No. 5-276675 (JP-A-5-276675) discloses a construction in which when excessively large tension acts on a charging cable, a tension detection portion informs a trip mechanism control portion of the excessively large tension, so that a breaker is opened to shut off the power reception point of the power source and therefore prevent the short-circuiting of the electric circuit.

However, in these related-art technologies, there is a problem that when a vehicle moves while being charged, the charging cable will be dragged and an infrastructure will be destroyed.

### SUMMARY OF THE INVENTION

This invention provides a vehicle, an electrical charging apparatus and a control method which are capable of preventing destruction of an electrical charging infrastructure even if a vehicle moves while being charged.

A vehicle in accordance with a first aspect of the invention is a vehicle that is electrically charged via an electrical charging apparatus, and that includes: a determination portion that determines movement of the vehicle; and an electrical charging portion which engages with the electrical charging apparatus and which maintains engagement with an electrical charging apparatus and charges the vehicle if the determination portion determines that amount of movement of the vehicle is less than a predetermined amount, and which releases the engagement with the electrical charging apparatus if the determination portion determines that the amount of movement of the vehicle is greater than or equal to the predetermined amount.

In the vehicle constructed in this manner, if the amount of movement of the vehicle is greater than or equal to the predetermined amount, the engagement of the vehicle with the electrical charging apparatus is released. As a result, if the vehicle moves while being charged, the engagement between the vehicle and the electrical charging apparatus is released, so that the destruction of the electrical charging apparatus due to movement of the vehicle can be prevented.

Besides, the electrical charging portion may ejects the electrical charging apparatus after releasing the engagement with the electrical charging apparatus, if the determination portion determines that the amount of movement of the vehicle is greater than or equal to the predetermined amount. In this case, since the electrical charging apparatus is ejected, if the vehicle moves while being charged, so that the destruction of the electrical charging apparatus due to movement of the vehicle can be prevented.

Besides, the vehicle may further include a vehicle speed sensor that detects vehicle speed, and the determination portion may determine movement of the vehicle after receiving a signal regarding vehicle speed from a vehicle speed sensor. In this case, since a signal from the vehicle speed sensor that is generally provided in vehicles is received, it is possible to obtain a signal regarding the movement of the vehicle without adding a new construction.

An electrical charging apparatus in accordance with a second aspect of the invention is an electrical charging apparatus that engages with a portion of a vehicle and electrically charges the vehicle, and that includes: a detection portion that detects an information commensurate with movement of the vehicle; and an engagement portion which maintains engagement with the vehicle if amount of movement of the vehicle commensurate with information detected by the detection portion is less than a predetermined amount, and which releases the engagement with the vehicle if the amount of movement of the vehicle is greater than or equal to the predetermined amount.

In the electrical charging apparatus constructed in this manner, the engagement of the electrical charging apparatus with the vehicle is released if the amount of movement of the vehicle is greater than or equal to the predetermined amount. As a result, if the vehicle moves while being charged, the engagement between the vehicle and the electrical charging apparatus is released, so that the destruction of the electrical charging apparatus due to movement of the vehicle can be prevented.

Besides, the detection portion may detect force that acts on a site of engagement between the vehicle and the engagement portion. In this case, movement of the vehicle can be detected without using a vehicle speed sensor, and therefore the movement of the vehicle can be detected regardless of the construction of the vehicle side.

Besides, the electrical charging apparatus may further include an electrical charging control portion that stops charging of the vehicle if the amount of movement of the vehicle is greater than or equal to the predetermined amount. In this case, when the amount of movement of the vehicle is greater than or equal to the predetermined amount and therefore the engagement between the engagement portion and the vehicle is released, the electrical charging apparatus stops charging the vehicle, so that waste of electric power can be prevented.

A third aspect of the invention is a control method for electrically charging a vehicle via an electrical charging apparatus, the control method including: making a determination about movement of the vehicle; and maintaining engagement with the electrical charging apparatus and charging the vehicle if it is determined that amount of movement of the vehicle is less than a predetermined amount, and ejecting the electrical charging apparatus if it is determined that the amount of movement of the vehicle is greater than or equal to the predetermined amount.

Since the charging is controlled in this manner, the engagement of the vehicle with the electrical charging apparatus is released if the amount of movement of the vehicle is greater than or equal to the predetermined amount. As a result, if the vehicle moves while being charged, the engagement between the vehicle and the electrical charging apparatus is released, so that the destruction of the electrical charging apparatus due to movement of the vehicle can be prevented.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a schematic diagram of a vehicle that is charged by an electrical charging apparatus in accordance with Embodiment 1 of the invention;

FIG. 2 is a block diagram showing a state in which a vehicle and an electrical charging apparatus in accordance with Embodiment 1 of the invention are engaged together;

FIG. 3 is a diagram for minutely describing the engagement between a charging-purpose plug of the electrical charging apparatus and an electrical charging portion of the vehicle;

FIG. 4 is a cross-sectional view taken along line IV-IV in FIG. 3, showing details of a structure of an electrical charging portion of a hybrid vehicle;

FIG. 5 is a diagram for describing a construction at an early stage of the engagement of the charging-purpose plug to the electrical charging portion;

FIG. 6 is a diagram for describing a state in which the charging-purpose plug is engaged to the electrical charging portion and the charging is being performed;

FIG. 7 is a diagram for describing a state in which the charging-purpose plug is disengaged after the hybrid vehicle has moved a predetermined amount or more;

FIG. 8 is a flowchart for describing the release and continuation of the engagement in the hybrid vehicle in accordance with an embodiment of the invention;

FIG. 9 is a diagram for minutely describing the engagement between a charging-purpose plug of an electrical charging apparatus and an electrical charging portion of a vehicle in accordance with Embodiment 2 of the invention;

FIG. 10 is a diagram for describing a construction at an early stage of the engagement of the charging-purpose plug to the electrical charging portion;

FIG. 11 is a diagram for describing a state in which the charging-purpose plug is engaged with the electrical charging portion, and charging is being performed; and

FIG. 12 is a diagram for describing a state in which the engagement of the charging-purpose plug is released after the hybrid vehicle has moved a predetermined amount or more.

### DETAILED DESCRIPTION OF EMBODIMENTS

Hereinafter, embodiments of the invention will be described with reference to the drawings. In conjunction with embodiments below, the same or comparable portions are denoted by the same reference numerals, and redundant descriptions thereof are omitted. Besides, it is possible to combine embodiments.

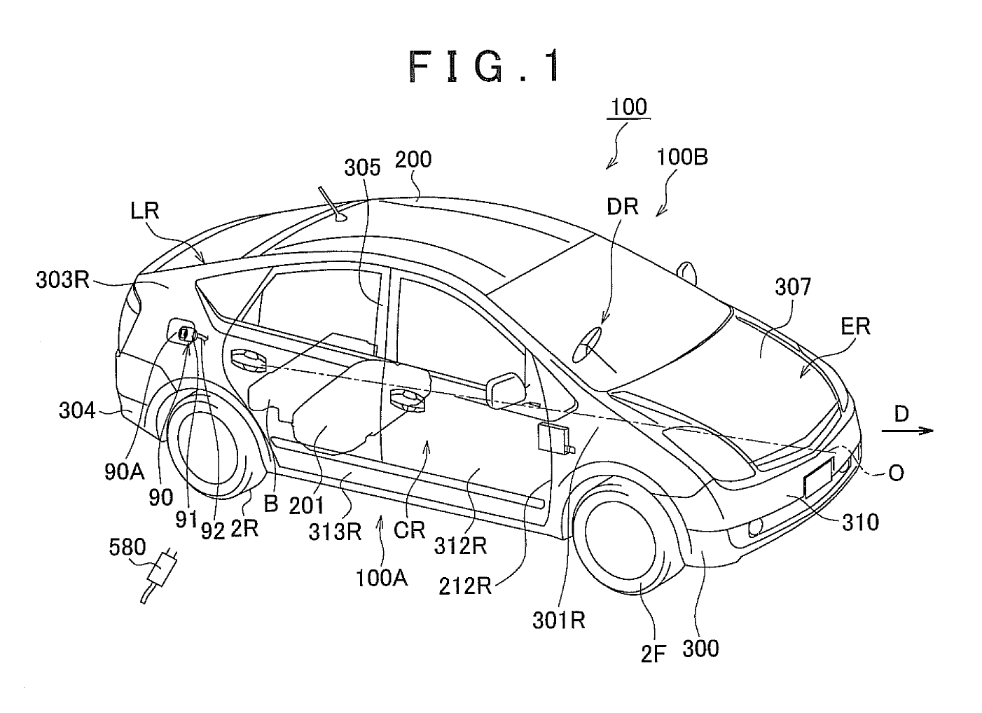

FIG. 1 is a schematic diagram of a vehicle that is charged by an electrical charging apparatus in accordance with Embodiment 1 of the invention. Referring to FIG. 1, a hybrid vehicle 100 includes a vehicle main body 200 formed of a body and exterior parts, a pair of front wheels (tire wheels) 2F provided on a front-side portion of the hybrid vehicle 100 in the traveling direction D, and a pair of rear wheels (tire wheels) 2R provided on a rear-side portion of the vehicle in the traveling direction D.

The vehicle main body 200 includes an engine compartment ER that is provided in a front-side portion of the hybrid vehicle 100 in the traveling direction D, an occupant compartment CR adjacent to a rearward side of the engine compartment ER in the traveling direction D, and a trunk compartment LF adjacent to a rearward side of the occupant compartment CR in the traveling direction D.

The body of the vehicle main body 200 adopted herein is, for example, a monocoque body. This body includes a front wall portion that is provided at a front surface side in the traveling direction D and that partially defines the engine compartment ER, a compartment wall portion that partially defines the occupant compartment CR, and a rearward wall portion that is provided rearward in the traveling direction D from the compartment wall portion of the vehicle main body 200.

A side surface of the body has an opening portion 212R that communicates with the occupant compartment CR and that allows occupants to enter the occupant compartment CR.

A plurality of exterior parts are mounted on surfaces of the body that is constructed as described above. In this manner, the vehicle main body 200 is constructed.

The exterior parts of the main body 200 include a front face 310 provided on a front surface side of the vehicle main body 200, a front bumper 300 provided on a lower side of the front face 310, a front fender 301R that is provided so as to cover a side surface of the front wall portion, and a front door 312R and a rear door 313R that are provided so as to be able to open and close the opening portion 212R.

The exterior parts further include a hood 307 as an upper lid of the engine compartment ER, a rear fender 303R that is provided rearward of the rear door 313R in the traveling direction D, and a rear bumper 304 provided below the rear fender 303R.

In the occupant compartment CR, there are provided a driver's seat for a driver that operates the hybrid vehicle 100, a navigator's seat placed at a side of the driver's seat in the width direction of the hybrid vehicle 100, and a rear seat that is provided at the rear side of the navigator's seat and the driver's seat. The driver's seat is offset from the center line O of the hybrid vehicle 100 which extends in the traveling direction D toward a right-side surface 100A (one of the side surfaces) of the hybrid vehicle 100.

An internal combustion engine that generates motive power for driving the front wheels 2F is housed in the engine compartment ER. A fuel tank 201 that contains gasoline, ethanol (a liquid fuel), propane gas (a gaseous fuel), etc. is provided at a site that is located under the rear seat in the occupant compartment CR positioned on the rear side of the engine compartment ER in the traveling direction D. A fuel cell, or a battery (electricity storage) B, such as a large-capacity capacitor or the like, is disposed rearward of the rear seat in the traveling direction D. Thus, the fuel tank (second reservoir portion) 201 and the battery B are positioned to the rear side in the traveling direction D, relative to the engine.

It is to be noted herein that the hybrid vehicle 100 is constructed so that a fuel supply connector (first energy source supply portion) 191 can be connected thereto, that is, the hybrid vehicle 100 is provided with a fuel supply portion (first connection portion) for supplying a fuel, for example, gasoline, ethanol, etc., to the fuel tank 201, so that the fuel tank 201 can be replenished with the fuel.

The hybrid vehicle 100 is also equipped with an electrical charging portion (second connection portion) 90 to which a connector (second energy source supply portion) connected to an external alternating-current electric power source can be connected (can be detachably attached).

The engine compartment ER houses a trans-axle, besides the internal combustion engine that generates motive power for driving the front wheels 2F.

The electrical charging portion 90 includes a connection portion 91 which is provided on the body and to which a charging-purpose plug 580 is connectable, a lid portion 90A that is formed on the rear fender 303R for exposing the connection portion 91 to the outside and housing the connection portion 91 within the hybrid vehicle 100, and wiring 92 that is connected to the connection portion 91. The charging-purpose plug 580 herein is a charging-purpose connector for supplying electric power to the battery B to charge the battery B, and for supplying electric power to the battery B from a commercial electric power source (e.g., a single-phase alternating-current power source of 100 V in Japan). Examples of the charging-purpose plug 580 include an electric plug that is connected to a common household electric power source.

The electric power transfer method between the charging-purpose plug 580 and the electrical charging portion 90 may be of a contact (conductive) type in which at least a portion of the charging-purpose plug 580 and at least a portion of the electrical charging portion 90 directly contact each other, or may also be of a non-contact (inductive) type.

The electric power supplied from the charging-purpose plug 580 is supplied to the battery B via an electric motor, an inverter, and a voltage-raising converter. It is to be noted herein that the alternating-current electric power supplied from the charging-purpose plug 580 is converted into direct-current electric power by the inverter. Then, the direct-current electric power is stored into the battery B as an electricity storage apparatus.

The electrical charging portion 90 is provided on a side surface 100A, of two side surfaces 100A and 100B that are opposite each other in the width direction of the hybrid vehicle 100, while the fuel supply portion is provided on the other side surface 100B.

It is to be noted herein that, generally, the probability of the hybrid vehicle 100 being damaged by external force from the outside is relatively high at a front-side portion of the vehicle in the traveling direction D and at a rear-side portion of the vehicle in the traveling direction D, whereas the incidence of damage to a side surface portion of the vehicle is relatively low.

The electrical charging portion 90 is provided on the driver-side side surface 100A, and is close to the driver's seat. Therefore, when a driver of the vehicle is to perform a charging operation, the driver can easily start the charging operation.

The electrical charging portion 90 is provided at a position remote from the engine compartment ER. This facilitates securement of a space for housing the electrical charging portion 90, and therefore substantially prevents contact of the electrical charging portion 90 with another appliance and therefore damage thereof or the like.

Furthermore, since the electrical charging portion 90 is disposed remote from the engine compartment ER, degradation of the electrical charging portion 90 by heat from the engine is substantially avoided. Therefore, the need for subjecting the electrical charging portion 90 to a process for heat protection or resistance is reduced, so that the cost can be decreased.

The number of the electrical charging portions 90 is not limited to one, but a plurality of electrical charging portions 90 may be provided. If a plurality of electrical charging portions 90 are provided, the charging-purpose plug 580 will likely be able to be inserted into at least one of the electrical charging portions 90 even in the case where the charging cable is short.

Although this embodiment has been described in conjunction with the case where the hybrid vehicle 100 is charged, electric power can be supplied from the charging-purpose plug 580 not only to a hybrid vehicle but also to an electric motor vehicle that is not equipped with an internal combustion engine.

Furthermore, electric power may be supplied to not only a motor vehicle that uses electric power as a motive power source but also a motor vehicle that uses electric power exclusively for purposes other than drive force (motive power of the vehicle).

Besides, it suffices that the vehicle as an object to which electric power is supplied be a vehicle that has two or more wheels. Specifically, the vehicle may be not only a four-wheel vehicle as shown in FIG. 1, but also a two-wheel vehicle, or a vehicle having six or more wheels, such as a truck or the like.

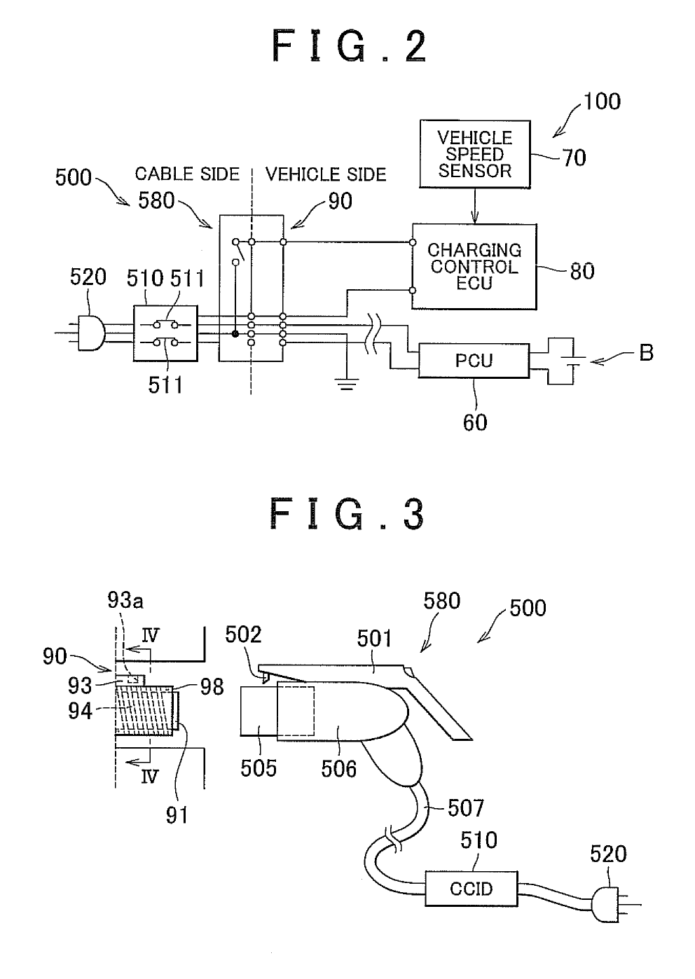

FIG. 2 is a block diagram showing a state in which a vehicle and an electrical charging apparatus in accordance with Embodiment 1 of the invention are engaged. Referring to FIG. 2, a hybrid vehicle 100 has an electrical charging portion 90. The hybrid vehicle 100 is equipped with a battery B, a PCU (Power Control Unit) 60 that is connected to the battery B and that carries out the conversion between alternating current and direct current and also the voltage boost, an electrical charging control ECU (Engine Control Unit) 80 that controls the charging control at the time of electrical charging, a vehicle speed sensor 70 that detects the speed of the hybrid vehicle 100 and that sends information about the vehicle speed to the electrical charging control ECU 80, and an electrical charging portion 90 that engages with a cable to receive electric power.

The battery B is an electricity storage apparatus that stores electric power. The battery B employed herein may be not only a battery that involves a chemical change, such as a nickel hydride battery, a lithium-ion battery, etc., but also an electricity storage apparatus that does not involve a chemical change, such as a capacitor or the like.

The PCU 60 is provided between the battery B and a three-phase alternating-current motor (not shown), and converts direct-current electric power stored in the battery into alternating-current electric power that is to be used by the three-phase alternating-current motor. Incidentally, in the case where a direct-current motor is used as the electric motor, the alternating-current/direct-current conversion function of the PCU may be omitted.

Furthermore, the PCU 60 has a converter function of converting a difference between the voltage of the battery B and the voltage that is used by the motor if there is any difference therebetween.

The electrical charging control ECU 80 controls the charging condition at the time of electrical charging. Concretely, the electrical charging control ECU 80 adjusts the charging condition so that the battery B is not overcharged but is supplied with electric power according to the capacity of the battery B. Besides, if excessive heat generation occurs in an electrical charging path, the electrical charging control ECU 80 reduces the current for charging in order to restrain the heat generation. The vehicle speed sensor 70 detects a vehicle speed signal for controlling the vehicle. This vehicle speed sensor 70 sends this vehicle speed signal to the electrical charging control ECU 80. If the vehicle speed obtained from the vehicle speed sensor 70 is greater than or equal to a predetermined value, the electrical charging control ECU 80 breaks a circuit so that the charging of the battery B from an external source is not allowed.

The electrical charging portion 90 is a portion which is used as an interface between the vehicle and a cable, and into which an external charging-purpose plug is inserted. The electrical charging portion 90 may be covered with a predetermined lid for preventing the exposure to wind, rain, etc., and may be constructed so as to be exposed to the outside only at the time of electrical charging.

The electrical charging apparatus 500 has a plug 520, a charging cable box 510 that is connected to the plug 520, and a charging-purpose plug 580 that is connected to the charging cable box 510 and that engages with the hybrid vehicle 100.

The plug 520 is fitted to an electrical outlet of a home, or the like, so as to receive electric power. Relays 511 are housed in the charging cable box 510. Using the relays 511, electric power is supplied and stopped. The charging-purpose plug 580 is fitted to the electrical charging portion 90 that is provided in the hybrid vehicle 100, so as to supply electric power to the hybrid vehicle 100.

Next, engagement portions between the charging-purpose plug and the vehicle will be described in detail. FIG. 3 is a diagram for minutely describing the engagement between the charging-purpose plug of the electrical charging apparatus and the electrical charging portion of the vehicle. Referring to FIG. 3, the electrical charging portion 90 of the vehicle has a connection portion 91 as a central member, a coil spring 94 that is provided on an outer periphery of the connection portion 91, a protrusion portion 93 that engages with the charging-purpose plug, and a groove portion 93a that is formed in the protrusion portion 93. The charging-purpose plug 580 has a main body portion 506, a tubular body 505 attached to the main body portion 506, an arm portion 501 attached to the main body portion 506, and a nail portion 502 attached to a distal end of the arm portion 501. A charging cable 507 is connected to the charging-purpose plug 580. Through the charging cable 507, electric power is supplied to the charging-purpose plug 580.

In the electrical charging portion 90, the coil spring 94 is provided on the outer periphery of the connection portion 91. That is, the coil spring 94 is disposed within a vehicle-side electrical inlet of the electrical charging portion 90. The coil spring 94 is disposed within the tubular body 98. The connection portion 91 is a portion that contacts the charging-purpose plug 580 as a charging-purpose connector and that receives electric power from the charging-purpose plug 580. The protrusion portion 93 is fixed to the vehicle body, and is constructed so that the groove portion 93a of the protrusion portion 93 and the nail portion 502 fit to each other.

Various members of the charging-purpose plug 580 are attached to the main body portion 506 of the charging-purpose plug 580. The tubular body 505, which is attached to a distal end of the charging-purpose plug 580, contacts the tubular body 98 in which the coil spring 94 is disposed, and pushes the tubular body 98 into the vehicle. The arm portion 501 is movably attached to the main body portion 506. As the arm portion 501 is pivoted, the distance between the nail portion 502 attached to the distal end of the arm portion 501 and the tubular body 505 changes.

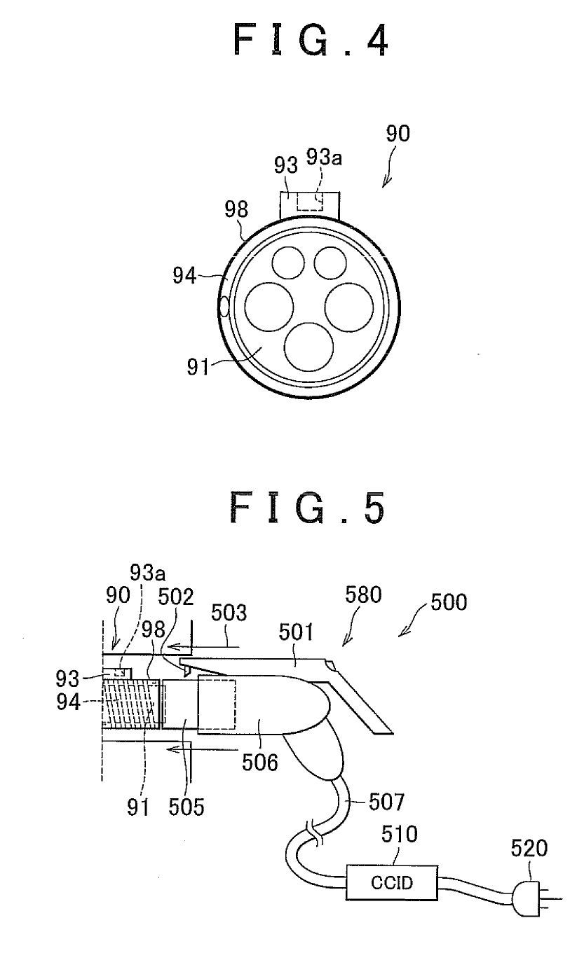

FIG. 4 is a sectional view minutely showing a structure of the electrical charging portion of the hybrid vehicle taken along line IV-IV in FIG. 3. Referring to FIG. 4, the coil spring 94 is disposed within the circular tubular body 98 in the electrical charging portion 90. The connection portion 91 is disposed on an inner periphery side of the tubular body 98. The connection portion 91 has a plurality of holes for supplying electric power, and a terminal (not shown) is disposed in each one of the holes.

FIG. 5 is a diagram for describing a construction at an early stage in which the charging-purpose plug is engaged with the electrical charging portion. Referring to FIG. 5, in the case where electrical charging is to be started using the charging-purpose plug 580, the charging-purpose plug 580 is firstly moved in a direction as shown by arrows 503 in FIG. 5 from a position thereof as shown in FIG. 3. Due to this, the tubular body 505 of the charging-purpose plug 580 and the tubular body 98 of the electrical charging portion 90 of the vehicle closely face each other.

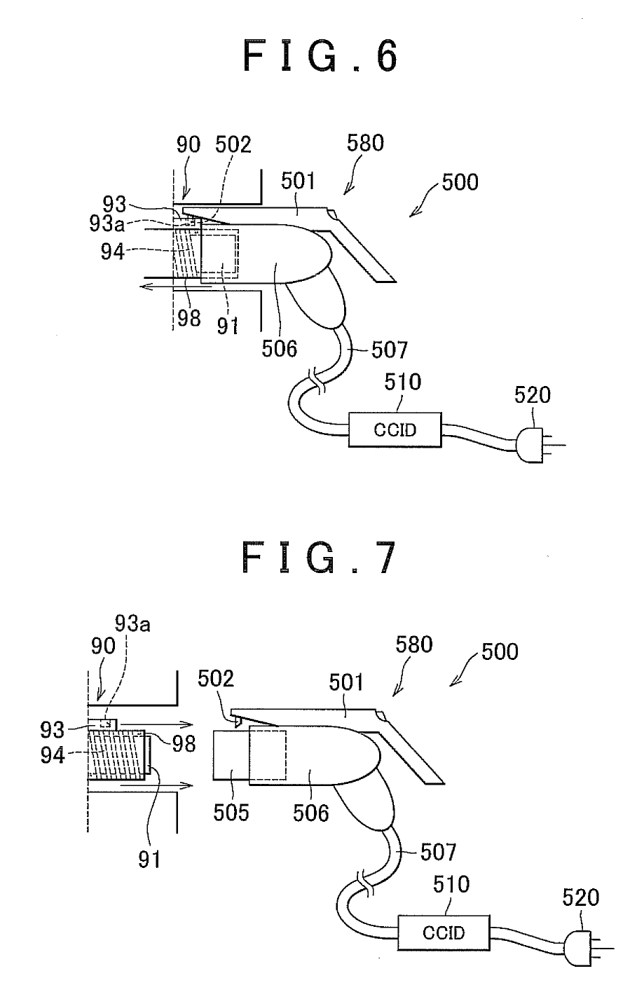

FIG. 6 is a diagram for describing a state in which the charging-purpose plug is engaged with the electrical charging portion, and electrical charging is being performed. Referring to FIG. 6, the charging-purpose plug 580 is further moved from the position shown in FIG. 5 toward the electrical charging portion 90. Due to this, the coil spring 94 is compressed. Besides, the nail portion 502 engages with the groove portion 93a of the protrusion portion 93. The connection portion 91 of the electrical charging portion 90 fits to the main body portion 506 of the charging-purpose plug 580. As a result, the connection portion 91 and the main body portion 506 are electrically connected, assuming a state in which electrical charging is possible. Although the coil spring 94 presses the charging-purpose plug 580 back, the charging-purpose plug 580 does not separate from the electrical charging portion 90 since the nail portion 502 is engaged with the groove portion 93a. In this state, it is possible to supply electric power to the hybrid vehicle side through the plug 520, the charging cable box 510, the charging cable 507 and the charging-purpose plug 580.

FIG. 7 is a diagram for describing a state in which the engagement of the charging-purpose plug is released after the hybrid vehicle has moved a predetermined amount or more. Referring to FIG. 7, in the case where a hybrid vehicle having the electrical charging portion 90 has moved a predetermined amount or more, this movement is detected by the vehicle speed sensor 70. Concretely, the vehicle speed sensor 70 transmits a signal regarding the speed of the hybrid vehicle 100 to the electrical charging control ECU 80. The electrical charging control ECU 80 calculates the amount of movement of the hybrid vehicle 100 from the movement speed and the movement time of the hybrid vehicle 100 acquired from the vehicle speed sensor 70. Then, if the electrical charging control ECU 80 determines that the amount of movement is greater than or equal to a predetermined value, the electrical charging control ECU 80 stops the supply of electric power to the battery B. Furthermore, the electrical charging control ECU 80 releases the engagement between the charging-purpose plug 580 and the electrical charging portion 90. Concretely, a piezoelectric element may be provided on a bottom of the groove portion 93a shown in FIG. 7 so that the nail portion 502 will be ejected from the groove portion 93a by applying voltage to the piezoelectric element to deform the element. Besides, the arm portion 501 may be constructed so as to be actuatable by an electric motor, and the engagement between the nail portion 502 and the groove portion 93a may be released by supplying current to the motor that actuates the arm portion 501.

When the engagement between the groove portion 93a and the nail portion 502 is released, the charging-purpose plug 580 is pushed to a position apart from the electrical charging portion 90 as shown in FIG. 7 due to the coil spring 94 urging the charging-purpose plug 580. As a result, as shown in FIG. 7, the engagement of the charging-purpose plug 580 with the electrical charging portion 90 is released.

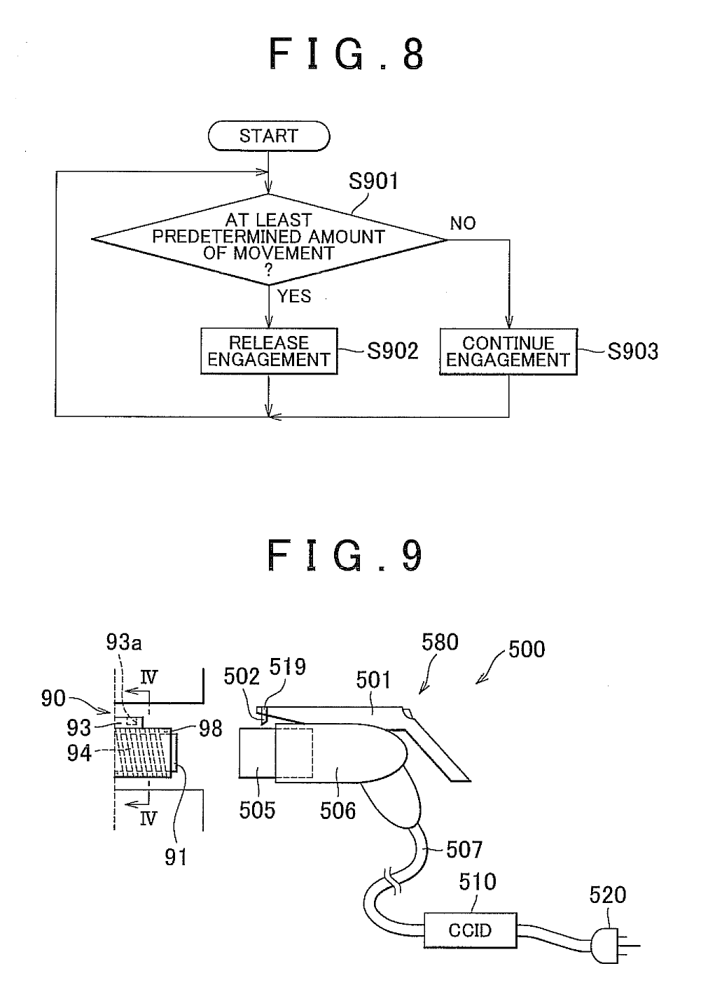

FIG. 8 is a flowchart for describing the release and continuation of the engagement in the hybrid vehicle in accordance with an embodiment of the invention. Firstly, after the electrical charging portion 90 is charged via the charging-purpose plug 580, it is determined whether or not the amount of movement of the hybrid vehicle is greater than or equal to a predetermined amount (step S901). This determination is performed by the electrical charging control ECU 80 on the basis of information from the vehicle speed sensor 70 as shown in FIG. 2. If the amount of movement is greater than or equal to a predetermined amount, the engagement between the charging-purpose plug 580 and the electrical charging portion 90 is released (step S902). If the amount of movement is less than the predetermined amount, the engagement between the charging-purpose plug 580 and the electrical charging portion 90 is continued (step S903). Then, it is determined again whether or not the amount of movement is greater than or equal to the predetermined amount (step S901). Incidentally, at the time of release of the engagement in step S902, supply of electric power to the charging-purpose plug 580 from the plug 520 is prevented by the relays 511.

That is, the hybrid vehicle 100 in accordance with the invention is engageable with a portion of the electrical charging apparatus 500, and includes the electrical charging control ECU 80 as a determination portion that makes a determination about motion of the hybrid vehicle 100, and the electrical charging portion 90 that is engaged with the hybrid vehicle 100 if the amount of movement of the hybrid vehicle 100 is less than a predetermined value, and that ejects the charging-purpose plug 580 in order to release the engagement with the hybrid vehicle 100 if the amount of movement of the hybrid vehicle 100 is greater than or equal to the predetermined amount. The electrical charging control ECU 80 receives a signal regarding the vehicle speed from the vehicle speed sensor 70 of the hybrid vehicle 100, and makes a determination about the motion of the hybrid vehicle 100.

In the case where the hybrid vehicle 100 moves while being charged, the electrical charging apparatus 500 constructed as described above immediately releases the engagement between the charging-purpose plug 580 and the electrical charging portion 90, and stops the supply of electric power to the charging-purpose plug 580 by using the relays 511 in the charging path. Due to this, the hybrid vehicle 100 will not drag the charging cable 507, and thus destruction of an infrastructure can be prevented.

FIG. 9 is a diagram for minutely describing the engagement between a charging-purpose plug of an electrical charging apparatus and an electrical charging portion of a vehicle in accordance with Embodiment 2 of the invention. Referring to FIG. 9, an electrical charging apparatus 500 in accordance with Embodiment 2 of the invention is different from the electrical charging apparatus 500 in accordance with Embodiment 1 in that a pressure sensor 519 is provided near a nail portion 502. The pressure sensor 519 detects that a charging cable 507 has been pulled if a hybrid vehicle 100 has moved on a slope or a frozen road when the charging cable 507 is connected to the hybrid vehicle 100, regardless of whether the vehicle is being charged or not. Immediately with the detection, the locking can be released on the side of the charging cable 507 to separate the charging cable 507 and the hybrid vehicle 100 from each other.

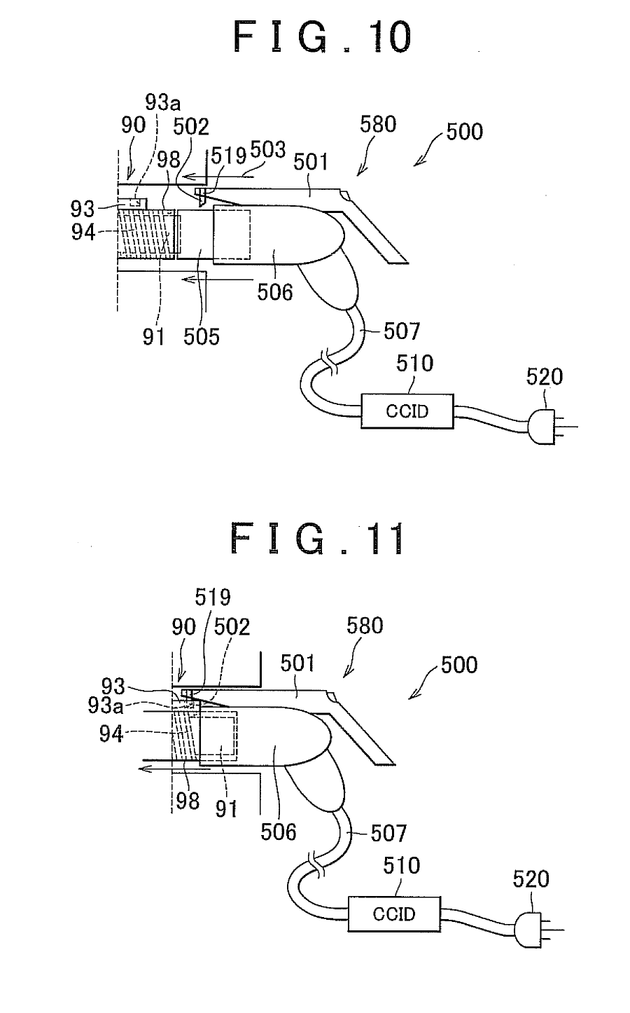

A cross-sectional view taken on line Iv-Iv in FIG. 9 is substantially the same as the cross-sectional view shown in FIG. 4. FIG. 10 is a diagram for describing a construction at an early stage of the engagement of the charging-purpose plug to the electrical charging portion. Referring to FIG. 10, in the case where the charging through the use of charging-purpose plug 580 is started, the charging-purpose plug 580 is firstly moved in a direction shown by arrows 503. Due to this, a tubular body 505 of the charging-purpose plug 580 and a tubular body 98 of the electrical charging portion 90 of the vehicle come to closely face each other.

FIG. 11 is a diagram for describing a state in which the charging-purpose plug is engaged with the electrical charging portion, and charging is being performed. Referring to FIG. 11, the charging-purpose plug 580 is further inserted from the position shown in FIG. 10 toward the electrical charging portion 90. Due to this, a coil spring 94 is compressed. Besides, the nail portion 502 engages with a groove portion 93a of a protrusion portion 93. A connection portion 91 of the electrical charging portion 90 fits to a main body portion 506 of the charging-purpose plug 580. As a result, the connection portion 91 and the main body portion 506 are electrically connected, assuming a state in which electrical charging is possible. Although the coil spring 94 presses the charging-purpose plug 580 back, the charging-purpose plug 580 does not separate from the electrical charging portion 90 since the nail portion 502 is engaged with the groove portion 93a. In this state, it is possible to supply electric power to the hybrid vehicle side through the plug 520, the charging cable box 510, the charging cable 507 and the charging-purpose plug 580.

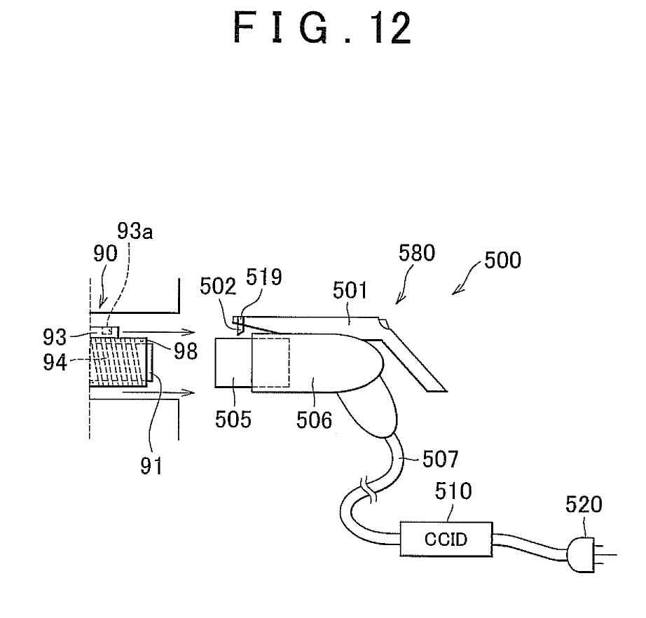

FIG. 12 is a diagram for describing a state in which the engagement of the charging-purpose plug is released after the hybrid vehicle has moved a predetermined amount or more. Referring to FIG. 12, in the case where the hybrid vehicle having the electrical charging portion 90 has moved a predetermined amount or more, this movement is detected by the pressure sensor 519. Concretely, the pressure sensor 519 transmits a signal regarding the pressure that acts on the nail portion 502, to the electrical charging control ECU 80. The electrical charging control ECU 80 calculates the amount of movement of the hybrid vehicle 100 on the basis of the information regarding the movement of the hybrid vehicle 100 which has been obtained from the pressure sensor 519. Then, if the electrical charging control ECU 80 determines that the amount of movement is greater than or equal to a predetermined value, the electrical charging control ECU 80 stops the supply of electric power to the battery B. Furthermore, the electrical charging control ECU 80 releases the engagement between the charging-purpose plug 580 and the electrical charging portion 90. Concretely, a piezoelectric element may be provided on a bottom of the groove portion 93a shown in FIG. 12 so that the nail portion 502 will be ejected from the groove portion 93a by applying voltage to the piezoelectric element to deform the element. Besides, the arm portion 501 may be constructed so as to be actuatable by an electric motor, and the engagement between the nail portion 502 and the groove portion 93a may be released by supplying current to the motor that actuates the arm portion 501.

When the engagement between the groove portion 93a and the nail portion 502 is released, the charging-purpose plug 580 is pushed to a position apart from the electrical charging portion 90 as shown in FIG. 12 due to the coil spring 94 urging the charging-purpose plug 580. As a result, as shown in FIG. 12, the engagement of the charging-purpose plug 580 with the electrical charging portion 90 is released.

The electrical charging apparatus 500 in accordance with Embodiment 2 is an electrical charging apparatus 500 that engages with a portion of the hybrid vehicle 100 to electrically charge the hybrid vehicle 100, and includes the pressure sensor 519 as a detection portion that detects motion of the hybrid vehicle 100, and the charging-purpose plug 580 as an engagement portion that engages with the hybrid vehicle 100 if the amount of movement of the hybrid vehicle 100 commensurate with the information detected by the pressure sensor 519 is less than a predetermined amount, and that releases the engagement with the hybrid vehicle 100 if the amount of movement of the hybrid vehicle 100 is greater than or equal to the predetermined amount.

The electrical charging apparatus 500 further includes the charging cable box 510 as an electrical charging control portion that stops charging the hybrid vehicle 100 if the amount of movement of the hybrid vehicle 100 is greater than or equal to the predetermined amount.

In Embodiment 2, the electrical charging control ECU 80 as a determination portion makes a determination about motion of the hybrid vehicle 100 on the basis of the force that acts on the pressure sensor 519 as a sensor that detects the force that acts on an engaging portion between the hybrid vehicle 100 and the charging-purpose plug 580.

In the electrical charging apparatus in accordance with Embodiment 2 constructed as described above, the charging cable 507 side (the infrastructure side) is provided with the detection function and the lock releasing function. Therefore, even in the case where the charging cable 507 is connected to the hybrid vehicle 100 during a non-charging time and where the detection function of the hybrid vehicle 100 has been stopped and therefore the vehicle speed sensor does not function, the electrical charging apparatus is able to prevent the dragging of the charging cable 507 and therefore destruction of an infrastructure.

While the invention has been described above with reference to the embodiments, the foregoing embodiments can be modified in various manners. Firstly, although the foregoing embodiments employ the hybrid vehicle 100 as a vehicle, this is not restrictive, but the invention is also applicable to a so-called electric motor vehicle that does not have an engine.

Besides, although FIG. 1 shows a four-wheel motor vehicle, the number of wheels of the vehicle is not particularly limited. The invention is also applicable to an electrical charging apparatus for a vehicle that has less than four wheels, or more than four wheels.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A vehicle that is electrically charged via an electrical charging apparatus, comprising:
a determination portion that determines movement of the vehicle; and
an electrical charging portion which engages with the electrical charging apparatus and which maintains engagement with an electrical charging apparatus and charges the vehicle if the determination portion determines that amount of movement of the vehicle is less than a predetermined amount, and which releases the engagement with the electrical charging apparatus if the determination portion determines that the amount of movement of the vehicle is greater than or equal to the predetermined amount.

2. The vehicle according to claim 1, wherein
the electrical charging portion ejects the electrical charging apparatus after releasing the engagement with the electrical charging apparatus, if the determination portion determines that the amount of movement of the vehicle is greater than or equal to the predetermined amount.

3. The vehicle according to claim 1, further comprising a vehicle speed sensor that detects vehicle speed,
wherein the determination portion determines movement of the vehicle after receiving a signal regarding vehicle speed from a vehicle speed sensor.

4. An electrical charging apparatus that engages with a portion of a vehicle and electrically charges the vehicle, comprising:
a detection portion that detects an information commensurate with movement of the vehicle; and
an engagement portion which maintains engagement with the vehicle if amount of movement of the vehicle commensurate with information detected by the detection portion is less than a predetermined amount, and which releases the engagement with the vehicle if the amount of movement of the vehicle is greater than or equal to the predetermined amount.

5. The electrical charging apparatus according to claim 4, wherein the detection portion detects force that acts on a site of engagement between the vehicle and the engagement portion.

6. The electrical charging apparatus according to claim 4, further comprising an electrical charging control portion that stops charging of the vehicle if the amount of movement of the vehicle is greater than or equal to the predetermined amount.

7. A control method for electrically charging a vehicle via an electrical charging apparatus, comprising:
making a determination of movement of the vehicle; and
maintaining engagement of an electrical charging portion of the vehicle with the electrical charging apparatus and charging the vehicle if it is determined that amount of movement of the vehicle is less than a predetermined amount, and releasing the engagement if it is determined that the amount of movement of the vehicle is greater than or equal to the predetermined amount.
